(19) United States
(12) Patent Application Publication
(10) Pub. No.: US 2017/0171275 A1
(43) Pub. Date: Jun. 15, 2017

(54) Object Embedding in Multimedia

(71) Applicant: JBF INTERLUDE 2009 LTD., Tel Aviv (IL)

(72) Inventors: Jonathan Bloch, Brooklyn, NY (US); Barak Feldman, Tenafly, NJ (US); Yuval Hofshy, Kfar Saba (IL); Gary Weiss, Givatayim (IL); Tal Zubalsky, Brooklyn, NY (US)

(21) Appl. No.: 14/968,324

(22) Filed: Dec. 14, 2015

(51) Int. Cl. H04L 29/06; H04N 21/4402; H04N 21/472; H04N 21/44

(52) U.S. Cl. CPC H04L 65/602; H04L 65/4069; H04N 21/44016; H04N 21/440227; H04N 21/47205

(57) ABSTRACT

A system is provided for embedding and presenting objects in multimedia content in real-time. A computer processor provides a multimedia layer that facilitates display of multimedia content. A second computer processor provides an object layer contemporaneously with the multimedia layer, where the object layer is configured to displays one or more objects and to receive one or more commands to insert one or more additional objects. A database embodied in a non-transitory computer-readable storage medium stores the one or more additional objects and timing information and location information associated with the multimedia content.

### TECHNICAL FIELD

Embodiments of the invention generally relate to adding objects to multimedia content, and more particularly to systems and methods for adding a comment layer to a multimedia layer.

### BACKGROUND

In order to present object streams and multimedia streams (e.g., audio/video) simultaneously, the streams are typically encoded in advance by the owner or administrator of the multimedia. For example, an owner may use a tool that adds an annotation in the form of a text box to a video using interleaving encoding or some similar process. Once the encoding is complete, the object layer cannot be changed. To modify the object layer, the owner typically has to start from scratch with a tool like the one described above.

Intra-playback addition of objects to a multimedia stream is therefore presently limited. If consumers of content desire to add an object to a video stream, they are typically limited to a comment section or chat window that is separate from the displayed video and not necessarily synchronized with the video. Accordingly, valuable information may be lost because the objects are not proximal (in terms of time and coordinates) to elements of a video or specific segments of a video. For example, comments may be contemporaneously presented with content that is irrelevant to those comments.

Accordingly there is a need for systems and methods that address the limitations noted above, and more particularly, to facilitate intra-playback insertion of objects to multimedia content in a robust, seamless and information rich manner.

### SUMMARY

In general, various aspects of the systems, methods, and apparatus described herein are directed toward facilitating embedding objects in multimedia content during presentation of that multimedia content. Embodiments of the systems and methods described herein preserve timing and location information associated with multimedia content to provide a more robust and information rich experience for a viewer.

According to one aspect of the present invention, a computer-implemented method of embedding objects in multimedia content in real-time is presented. The method includes providing, by a first computer processor, a multimedia layer; providing, by a second computer processor, an object layer contemporaneously with the multimedia layer; during presentation of multimedia content by the multimedia layer, receiving a command to insert a first object at the object layer; and transmitting for storage, in response to the command, the first object and timing information and location information associated with the multimedia layer.

In one embodiment, the first object comprises text, an image, an audio file, a hyperlink, and combinations thereof.

In another embodiment, the command is initiated by one or more of a keyboard entry, a pointing device click, a menu section, a drag-and-drop, or combinations thereof.

In another embodiment, the multimedia content comprises video content. The video content may be further comprised of a collection of segments organized according to a download priority.

In another embodiment, the multimedia content is selectably presentable.

In another embodiment, the timing information and the location information associated with the multimedia layer are determined based on a playback time and a coordinate of content displayed by the multimedia layer.

In another embodiment, the object layer and the multimedia layer are presented in a browser or a locally resident application.

In another embodiment, the method may further include receiving at the object layer a second object, second timing information, and second location information, the second timing information and the second location information being associated with the multimedia content; and during presentation of multimedia content, presenting the second object with the multimedia content at a location and a time of the multimedia content based on the received second timing information and second location information.

In another embodiment, the method may further include receiving a plurality of objects at the object layer and presenting one or more of the plurality of objects by the object layer according to a defined policy. The policy may be based on the type of content.

In another embodiment, the method may further include presenting object information by the object layer. The object information may further comprise information about at least one object that has not been presented with the multimedia content.

According to another aspect of the present invention, a system for embedding and presenting objects in multimedia content in real-time is provided. The system may comprise a first computer processor configured to provide a multimedia layer that facilitates display of multimedia content; a second computer processor configured to provide an object layer contemporaneously with the multimedia layer, the object layer configured to display one or more objects and to receive one or more commands to insert one or more additional objects; and a database embodied in a non-transitory computer-readable storage medium, the database configured to store the one or more additional objects and timing information and location information associated with the multimedia content.

In one embodiment, the one or more objects are comprised of text, an image, an audio file, a hyperlink, and combinations thereof.

In another embodiment, the one or more commands are initiated by one or more of a keyboard entry, a pointing device click, a menu section, a drag-and-drop, or combinations thereof.

In another embodiment, the multimedia content comprises streamed video content.

In another embodiment, the multimedia content is selectably presentable.

In another embodiment, the multimedia content is comprised of a collection of segments ordered according to a download priority generated in real-time.

In another embodiment, the one or more displayed objects are displayed at a playback time of the multimedia content and at a coordinate location on the multimedia content.

In another embodiment, the method may further comprise the steps of receiving a plurality of objects at the object layer and displaying one or more of the plurality of objects by the object layer according to a defined policy associated with the type of content.

In another embodiment, the object layer is further configured to display object information about one or more objects to be displayed with the multimedia content.

The foregoing and other features and advantages of the present invention will be made more apparent from the descriptions, drawings, and claims that follow, all of which are exemplary of the principle(s) of the present invention. One of ordinary skill in the art, based on this disclosure, would understand that other aspects, embodiments, and advantages of the present invention exist.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates multimedia and object content displayed according to an exemplary embodiment;

FIG. 2 illustrates a system for embedding objects into multimedia content according to an exemplary embodiment of the invention;

FIG. 3 illustrates a flowchart of a process for collecting objects for insertion into an object layer according to an exemplary embodiment;

FIG. 4a illustrates a flowchart of a process for storing objects according to an exemplary embodiment;

FIG. 4b illustrates a flowchart of a process for retrieving objects according to an exemplary embodiment; and

FIG. 5 illustrates a flowchart of a process for presenting objects according to an exemplary embodiment.

### DETAILED DESCRIPTION

Described herein are various embodiments of methods and systems for embedding objects with multimedia content. The disclosed techniques may be used in conjunction with seamlessly assembled and selectably presentable multimedia content, such as that described in U.S. patent application Ser. No. 13/033,916, filed Feb. 24, 2011, and entitled, “System and Method for Seamless Multimedia Assembly,” and described in U.S. patent application Ser. No. 13/838,830, filed Mar. 15, 2013, and entitled, “System and Method for Synchronization of Selectably presentable Media Streams.” The entirety of both applications is hereby incorporated by reference.

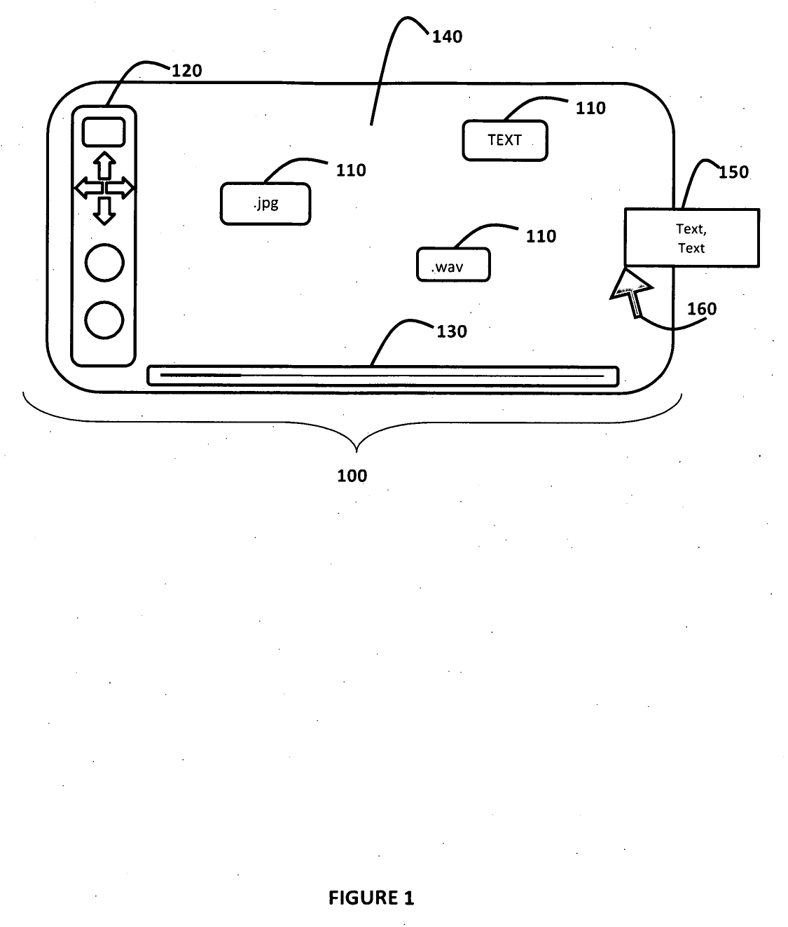

FIG. 1 is an illustration of multimedia content and objects that are being displayed according to an exemplary embodiment of the present invention. The Display 100 includes various Objects 110, a Control Panel 120, a Status Bar 130, and Multimedia Content 140 (which in this example is a video). Also illustrated are Pointer 160 and New Object 150. These elements of the Display 100 may be presented via a plurality of layers such that to a viewer they seem a unified scheme.

The Control Panel 120 may be used to control playback of the Multimedia Content 140. The Control Panel 120 may include selectable, clickable, and/or pressable buttons that facilitate the control. In one exemplary embodiment the Control Panel 120 is a graphical user interface.

The various Objects 110 are comprised of text, an image (.jpeg) and an audio file (.wav). The invention is not limited to these types of objects and one of ordinary skill in the art would understand that other types of objects and combinations of objects may be embedded with multimedia in accord with the present invention.

The Objects 110 may be associated with a specific time (or time frame) and location (e.g., an [x,y] coordinate pair, location in a video tree structure, etc.) of the Multimedia Content 140. The Status Bar 130, in this example, indicates that the Multimedia Content 140 is about one-fifth complete. The Status Bar 130 may also provide information about the location of objects. For example, The Status Bar 130 may include tick marks that indicate that an object will become visible at or around a point of progression through the Multimedia Content 140. Since the Objects 110 are associated with specific times in the Multimedia Content 140, as the video progresses new objects may be displayed, and the Objects 110 may change, disappear or be replaced by other objects.

Objects may be embedded in real-time while the Multimedia Content 140 is being played. Pointer 160 may be used to initiate embedding of an object at a specific location and time. The specific time may be substantially contemporaneous with a command or other action taken to initiate embedding of an object. However, some time may pass before the object and information are collected. Accordingly, in some embodiments, the Multimedia Content 140 may pause during the collection phase, though this is not required.

In this example, the New Object 150 is comprised of text. Though not shown, additional object information and conditions may also be provided. In some embodiments, the condition is a timing condition—i.e., the embedded object will be visible in playback from time x to time x+35s (or, e.g., frame ‘a’ to frame ‘b’). Conditions may also include the look and feel of the object (shadowing, transparency, border, etc.). In some embodiments, upon a selection action using the Pointer 160, a drop down menu will be presented from which different object types may be selected.

Object information is anything that may be useful for the management and/or presentation of an object. In some embodiments, object information may be used to filter certain objects. For example, information that is appropriate for users of a particular age (and inappropriate for users of other ages) may be identified with an age rating. Object information may also include the type of object as well as attributes (e.g., size, shape, color, etc.) of the object, which can be the basis for filtering. Object information may also include source information about the source of the object requested to be embedded, for example, information about the user, or in the case of an automated request, the application or business entity.

In some embodiments object information can include information about how the object should behave. An object may be editable by other users in a comments-type of fashion. Comments are essentially discussions between users. During the embedding process a user may indicate whether the New Object 150 should behave in a comment based fashion, where users can insert more objects with the New Object 150 in a ladder or tree-like structure. For example, if New Object 150 behaves in comments based fashion it may include a “reply” button or similar clickable link that facilitates insertion of an object in a tree-like structure with the New Object 150. In some embodiments, New Objet 150 may include features that facilitate social networking, such as “like,” “up-vote,” and “down-vote” buttons.

In one exemplary embodiment, the Multimedia Content 140 is selectably presentable multimedia content. Selectably presentable multimedia content is a form of non-linear content. Embodiment of selectably presentable multimedia content are described in U.S. Pat. No. 8,600,220, which is incorporated in its entirely herein by reference. Non-linear content can include interactive video structured in a video tree, hierarchy, or other form. A video tree can be formed by nodes that are connected in a branching, hierarchical, or other linked form. Nodes can each have an associated video segment, audio segment, graphical user interface (GUI) elements, and/or other associated media. Users (e.g., viewers) can watch a video that begins from a starting node in the tree and proceeds along connected nodes in a branch or path. Upon reaching a point during playback of the video where multiple video segments branch off from a segment, the user can interactively select the branch or path to traverse and, thus, the next video segment to watch.

In the case of selectably presentable multimedia content, some or all of the video segments in the video tree can be individually or collectively played for a user based upon the user's selection of a particular video segment, an interaction with a previous or playing video segment, or other interaction that results in a particular video segment or segments being played. The video segments can include, for example, one or more predefined, separate multimedia content segments that can be combined in various manners to create a continuous, seamless presentation such that there are no noticeable gaps, jumps, freezes, delays, or other visual or audible interruptions to video or audio playback between segments. In addition to the foregoing, “seamless” can refer to a continuous playback of content that gives the user the appearance of watching a single, linear multimedia presentation, as well as a continuous playback of multiple content segments that have smooth audio and/or video transitions (e.g., fadeout/fade-in, linking segments) between two or more of the segments.

In some instances, the user is permitted to make choices or otherwise interact in real-time at decision points or during decision periods interspersed throughout the multimedia content. Decision points and/or decision periods can occur at any time and in any number during a multimedia segment, including at or near the beginning and/or the end of the segment. Decision points and/or periods can be predefined, occurring at fixed points or during fixed periods in the multimedia content segments. Based at least in part on the user's choices made before or during playback of content, one or more subsequent multimedia segment(s) associated with the choices can be presented to the user. In some implementations, the subsequent segment is played immediately and automatically following the conclusion of the current segment, whereas in other implementations, the subsequent segment is played immediately upon the user's interaction with the video, without waiting for the end of the decision period or the end of the segment itself.

If a user does not make a selection at a decision point or during a decision period, a default, previously identified selection, or random selection can be made by the system. In some instances, the user is not provided with options; rather, the system automatically selects the segments that will be shown based on information that is associated with the user, other users, or other factors, such as the current date. For example, the system can automatically select subsequent segments based on the user's IP address, location, time zone, the weather in the user's location, social networking ID, saved selections, stored user profiles, preferred products or services, and so on. The system can also automatically select segments based on previous selections made by other users, such as the most popular suggestion or shared selections. The information can also be displayed to the user in the video, e.g., to show the user why an automatic selection is made. As one example, video segments can be automatically selected for presentation based on the geographical location of three different users: a user in Canada will see a twenty-second beer commercial segment followed by an interview segment with a Canadian citizen; a user in the US will see the same beer commercial segment followed by an interview segment with a US citizen; and a user in France is shown only the beer commercial segment.

Multimedia segment(s) selected automatically or by a user can be presented immediately following a currently playing segment, or can be shown after other segments are played. Further, the selected multimedia segment(s) can be presented to the user immediately after selection, after a fixed or random delay, at the end of a decision period, and/or at the end of the currently playing segment. Two or more combined segments can form a seamless multimedia content path or branch, and users can take multiple paths over multiple play-throughs, and experience different complete, start-to-finish, seamless presentations. Further, one or more multimedia segments can be shared among intertwining paths while still ensuring a seamless transition from a previous segment and to the next segment. The content paths can be predefined, with fixed sets of possible transitions in order to ensure seamless transitions among segments. The content paths can also be partially or wholly undefined, such that, in some or all instances, the user can switch to any known video segment without limitation. There can be any number of predefined paths, each having any number of predefined multimedia segments. Some or all of the segments can have the same or different playback lengths, including segments branching from a single source segment.

Traversal of the nodes along a content path in a tree can be performed by selecting among options that appear on and/or around the video while the video is playing. In some implementations, these options are presented to users at a decision point and/or during a decision period in a content segment. Some or all of the displayed options can hover and then disappear when the decision period ends or when an option has been selected. Further, a timer, countdown or other visual, aural, or other sensory indicator can be presented during playback of content segment to inform the user of the point by which he should (or, in some cases, must) make his selection. For example, the countdown can indicate when the decision period will end, which can be at a different time than when the currently playing segment will end. If a decision period ends before the end of a particular segment, the remaining portion of the segment can serve as a non-interactive seamless transition to one or more other segments. Further, during this non-interactive end portion, the next multimedia content segment (and other potential next segments) can be downloaded and buffered in the background for later playback (or potential playback).

A segment that is played after (immediately after or otherwise) a currently playing segment can be determined based on an option selected or other interaction with the video. Each available option can result in a different video and audio segment being played. As previously mentioned, the transition to the next segment can occur immediately upon selection, at the end of the current segment, or at some other predefined or random point. Notably, the transition between content segments can be seamless. In other words, the audio and video continue playing regardless of whether a segment selection is made, and no noticeable gaps appear in audio or video playback between any connecting segments. In some instances, the video continues on to another segment after a certain amount of time if none is chosen, or can continue playing in a loop.

In one example, the multimedia content is a music video in which the user selects options upon reaching segment decision points to determine subsequent content to be played. First, a video introduction segment is played for the user. Prior to the end of the segment, a decision point is reached at which the user can select the next segment to be played from a listing of choices. In this case, the user is presented with a choice as to who will sing the first verse of the song: a tall, female performer, or a short, male performer. The user is given an amount of time to make a selection (i.e., a decision period), after which, if no selection is made, a default segment will be automatically selected. The default can be a predefined or random selection. Of note, the media content continues to play during the time the user is presented with the choices. Once a choice is selected (or the decision period ends), a seamless transition occurs to the next segment, meaning that the audio and video continue on to the next segment as if there were no break between the two segments and the user cannot visually or audibly detect the transition. As the music video continues, the user is presented with other choices at other decisions points, depending on which path of choices is followed. Ultimately, the user arrives at a final segment, having traversed a complete multimedia content path.

Accordingly, in the case of non-linear and selectably presentable multimedia content, information about the specific segment or segments associated with the new object may also be collected.

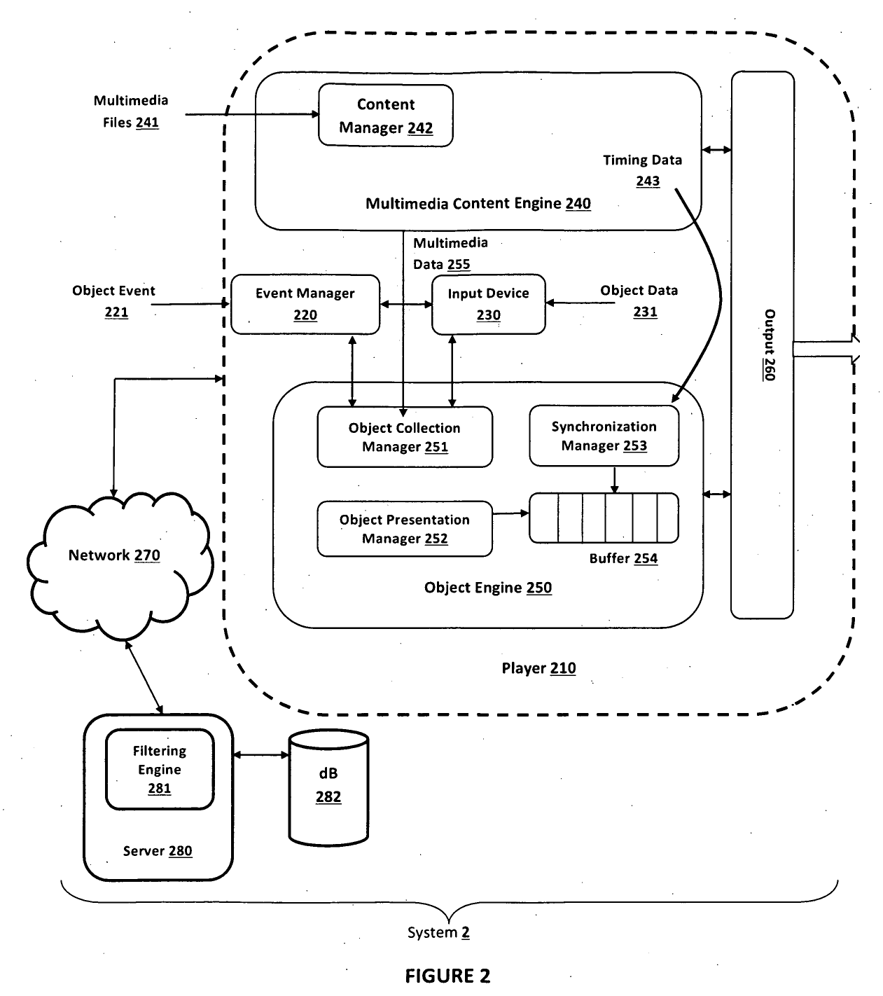

An exemplary System 2 for embedding and presenting objects within multimedia content will now be described with reference to FIG. 2. The System 2 includes a Player 210, a Server 280 and a Network 270.

The Player 210 manages the presentation of multimedia content and collection and presentation of objects. The Player 210 may be special purpose hardware (e.g., an ASIC), special purpose software executing on general purpose hardware, or some combination thereof. The general purpose hardware may take the form of a computer including a processing unit, a system memory, and a system bus that couples various system components including the system memory to the processing unit. The Player 210 may execute as a standalone application, an extension to an application, or in a browser, for example, in an applet.

The Player 210 includes an Event Manager 220, a Multimedia Content Engine 240, and an Object Engine 250. A user of the Player 210 may interact with the System 2 via an Input Device 230, and view the content by way of the Output 260, which facilitates the display of the multimedia content and objects.

The Event Manager 220 is configured to manage the embedding of an object with multimedia content. It will handle an Object Event 221 generated by a user to embed an object, for example, if a user clicks on the video and selects an object insertion. After an object embedding event has been created, the Event Manager 220 initializes the Input Device 230 and Object Collection Manager 251. Object Data 231, which includes the object for embedding as well as object information and conditions, may be input to the System 2 via the Input Device 230. The Event Manager 220 will also initiate transfer of Multimedia Data 255 from the Multimedia Content Engine 240 to the Object Collection Manager 251. The Multimedia Data 255 may include information about the multimedia content with which the object is being embedded, including, for example, location (including without limitation coordinate location and location in a video tree structure) and timing information. The Object Data 231 is also transmitted to the Object Collection Manager 251.

The Object Data 231, Multimedia Data 255, objects and information described herein may be transferred among the various elements of the System 2, at times as data files, at other times in binary data over machine-level interconnects such as a system bus, and may at times reside on a bus, in random access memory (RAM), in long-term memory, and combinations thereof.

The Input Device 230 may incorporate devices such as a touch screen, a touch pad, keypad, a keyboard, a scanner, a camera, an RFID reader, a pointing device (e.g., a mouse), etc. Other supported input devices may include a microphone, joystick, game pad, satellite dish, scanner, voice recognition device, toggle switch, pushbutton, or the like. These and other input devices are often connected to a processing unit through a user input interface, such as a parallel port, game port, universal serial bus (USB), etc. The input devices may also interface with the Player 210 via a wireless interface such as an 802.11a/b/g/n (Wi-Fi) interface, Bluetooth, or near field communication. In some embodiments, the Input Device 230 may present a user with a graphical user interface (GUI), which is customizable depending on the characteristics of the object data the System 2 is designed to handle.

The Object Collection Manager 251 is part of the Object Engine 250, which also includes an Object Presentation Manager 252, Synchronization Manager 253, and Buffer 254. It coordinates collection of the object to be embedded or updated. The Object Collection Manager 251 communicates with the Server 280 via the Network 270. In particular, the Object Collection Manager 251 transmits the object, Object Data 231, and Multimedia Data 255 to the Server 280 for processing and storage at the Database 282.

The Object Presentation Manager 252 coordinates the embedding of objects with multimedia content by way of an object layer. The Object Presentation Manager 252 requests object and object related information from the Server 281 based on the multimedia content that is being presented by the Player 210 and the Multimedia Content Engine 240. As the Server 280 returns objects, conditions, and object information such as timing information and location information (coordinate location and/or location in the video tree structure) associated with the multimedia content, the Object Presentation Manager 252 stores the objects, conditions, and object information. In one embodiment, the Object Presentation Manager 252 may store all of the objects, conditions and object information and then register display events for all of the objects in coordination with the Synchronization Manager 253. In another embodiment, the Object Presentation Manager 252 may register a display event for each object as each object is received such that the Object Presentation Manager 252 is receiving the objects, conditions, and object information and registering display events in parallel. The Synchronization Manager 253 uses Timing Data 243 associated with the multimedia content to manage the Buffer 254 so that the objects are displayed at the object layer at the appropriate time and location and in a manner that appears seamless with the multimedia content.

The Server 280 may be part of a local network that also includes some or all of the components of the System 2, or may be part of a network remote to the components, including the Player 210. The Server 280 has access to the Database 282, which may be internal to the Server 280 or may be remotely accessed.

The Database 282 stores the objects and Object Data 231 that is used by the Object Engine 250. The Database 282 may be indexed according to the multimedia content that is associated with a specific object.

The Database 282 may be a searchable database and may comprise, include or interface to a relational database or noSQL database (such as Cassandra NoSQL). Other databases, such as a query format database, a Structured Query Language (SQL) database, a storage area network (SAN), or another similar data storage device, query format, platform or resource may be used. Database 282 may each comprise a single database or a collection of databases, dedicated or otherwise. In some embodiments, Database 282 may store or cooperate with other databases to store the various data and information described herein. In some embodiments, Database 282 may comprise a file management system, program or application for storing and maintaining data and information used or generated by the various features and functions of the systems and methods described herein.

In System 2, the Server 280 includes a Filtering Engine 281 that filters objects according to customizable filtering algorithms. For example, objects may be filtered according to the type of the object, the age of the object, the source (e.g., user or connections to the original user) of the object, an attribute of the source (e.g., the number of ‘likes’ a user has received for their objects), characteristics of the content (e.g., appropriate for mature audiences), the subject matter of the object, and the like. In other exemplary embodiments the Filtering Engine 281 may be incorporated into the Player 210 or the Object Engine 250.

The Network 270 facilitates communication among the various elements of the System 2, and may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Network 270 may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link.

In some embodiments, Network 270 may comprise a satellite communications network; such as a direct broadcast communication system (DBS) having the requisite number of dishes, satellites and transmitter/receiver boxes, for example. Network 270 may also comprise a telephone communications network, such as the Public Switched Telephone Network (PSTN). In another embodiment, Network 270 may comprise a Personal Branch Exchange (PBX), which may further connect to the PSTN.

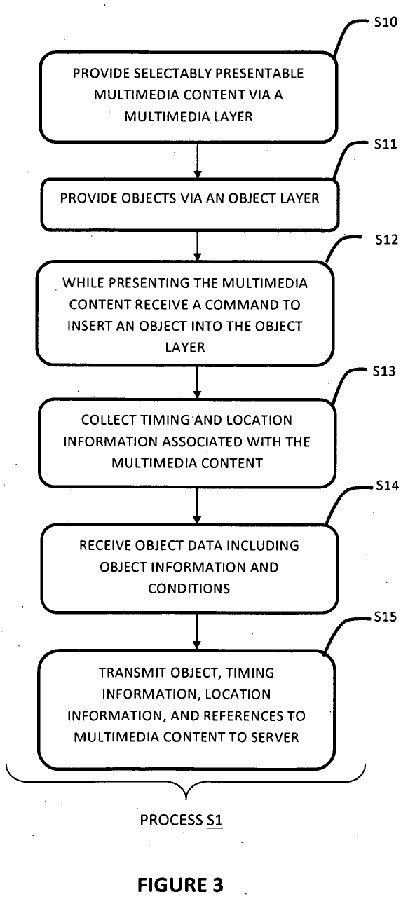

An exemplary embedding of an object with multimedia content by a system like the one described in System 2 will now be described with reference to FIG. 3.

At the outset, multimedia content is presented and displayed via a multimedia layer (Step S10). In this example the multimedia content is selectably presentable multimedia content, and is comprised of a plurality of segments that branch from other segments. Objects are presented and displayed via an object layer (Step S11). While the multimedia content is being presented, a command is received to insert an object into the object layer (Step S12) and thereby embed the object with the multimedia content. The object may be a new object, or it may be a request to add to an existing object such as a group of comments. Timing information and location information associated with the multimedia content are collected (Step S13) The object, object data (including object information and conditions), and reference information associated with the multimedia content are collected (Step S14). Object data may be input by a user, automatically generated and input based on the object or user who inserted the object, and combinations thereof. The object, object data, timing information, location information and reference information associated with the multimedia content are transmitted to a server for storage (Step S15). Transmission to a server for storage may occur simultaneously with collection or after the entire collection process is complete.

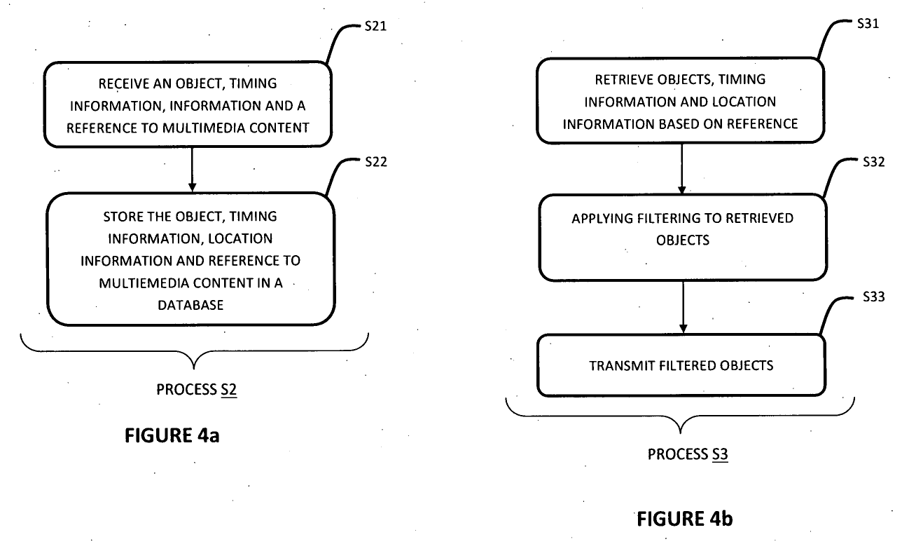

An exemplary operation of a server managing objects like the one described in System 2 will now be described with reference to FIG. 4a and FIG. 4b.

The server receives the object, the object data, timing information, location information, and references to the multimedia content (Step S21). The server than stores the object, the object data, timing information, location information, and references to the multimedia content (Step S22).

If the server receives a request for an object, it will receive a reference to multimedia content and then retrieve the objects, timing information, location information, and object data based on the reference (Step S31). In some embodiments the server is configurable and may be configured to retrieve, for example, objects and associated information based on the user, type of content, the subject matter of the content, or combinations of the same. Once retrieval is complete, any retrieved objects are filtered (Step S32). In some embodiments, filtering instructions are received with the reference to the multimedia content. In another embodiment, filtering is performed according to customizable presets.

Filtering may be applied to an entire object or just to a part of an object. For example, in the case of text, specific words or phrases may be deemphasized or even eliminated/hidden. An entire object may be eliminated/hidden. Alternatively, filtering could be used to emphasize all or part of an object, for example, highlighting specific words or phrases.

Once the filtering process is complete, the filtered objects are transmitted, along with the location and timing information, for presentation (Step S33).

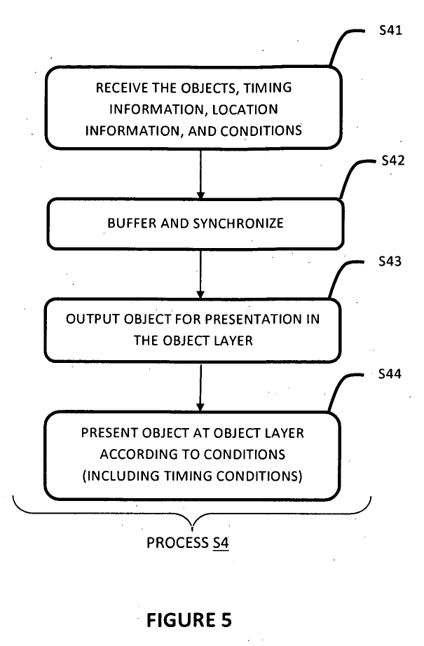

An exemplary presentation of an object will now be described with reference to FIG. 5. The objects, conditions and object information such as timing information and location information are received from storage (Step S41). Based on the timing information and location information, each object is buffered for presentation by the object layer contemporaneously with the multimedia content layer (Step S42). Each object is output for presentation by the object layer (Step S43) at the associated time, location (coordinate location and/or location within a video tree structure) and according to any other conditions/constraints associated with the object and/or the multimedia content. Each output object is presented at the object layer according to any conditions (Step S44), including timing conditions for visibility (e.g., visible from time t₁ to t₂).

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

1. A computer-implemented method of embedding objects in video in real-time, the method comprising:
displaying, by a multimedia content engine, non-linear video content to a first user using a dynamic display, wherein the non-linear video content is structured as a plurality of nodes that are each associated with a video segment and connected to at least one other node by at least one branch, wherein the first user can interactively select the branch to traverse and therefore the video segment that is displayed by the multimedia content engine;
displaying, by an object presentation manager, an object layer superimposed on the displayed non-linear video content using the dynamic display, the object layer including at least one object defined by a second user and retrieved from a second computer;
during presentation of the non-linear video content, receiving at the object layer a command from the first user to insert a first object at the object layer; and
transmitting for storage to the second computer, in response to the command, the first object and timing information and location information associated with insertion of the first object.

2. The computer-implemented method of claim 1, wherein the first object comprises text, an image, an audio file, a hyperlink, and combinations thereof.

3. The computer implemented method of claim 1, wherein the command is initiated by one or more of a keyboard entry, a pointing device click, a menu section, a drag-and-drop, or combinations thereof.

4. The computer-implemented method of claim 1 further comprising displaying, by the multimedia content engine, audio content using the dynamic display.

5. (canceled)

6. The computer-implemented method of claim 1, wherein the timing information and the location information associated with insertion of the first object are determined based on a playback time and a screen coordinate of the displayed video content.

7. The computer-implemented method of claim 1, wherein the non-linear video content is comprised of a collection of segments organized according to a download priority.

8. The computer-implemented method of claim 1, wherein the object layer and the non-linear video content are presented in a browser or a locally resident application.

9. The computer-implemented method of claim 1, the method further comprising:
receiving at the object layer a second object, second timing information, and second location information, the second timing information and the second location information being associated with the second object; and
during presentation of the non-linear video content, presenting the second object with the non-linear video content at a location and a time of the non-linear video content based on the received second timing information and second location information.

10. The computer-implemented method of claim 9, further comprising receiving a plurality of objects at the object layer and presenting one or more of the plurality of objects by the object layer according to a defined policy.

11. The computer-implemented method of claim 10, wherein the policy is based on the type of content.

12. The computer-implemented method of claim 9, further comprising presenting object information by the object layer, wherein the object information comprises information about at least one object that has not been presented with the non-linear video content.

13. A system for embedding and presenting objects in video in real-time, the system comprising:
a multimedia content engine configured to display non-linear video content to a first user using a dynamic display, wherein the non-linear video content is structured as a plurality of nodes that are each associated with a video segment and connected to at least one other node by at least one branch, wherein the first user can interactively select the branch to traverse and therefore the video segment that is displayed by the multimedia content engine;
an object presentation manager configured to provide an object layer superimposed on the displayed non-linear video content using the dynamic display, the object layer configured to display one or more objects defined by a second user and to receive one or more commands from the first user to insert one or more additional objects; and
a second computer in communication with the multimedia content engine, the second computer comprising a database embodied in a non-transitory computer-readable storage medium, the database configured to store the one or more additional objects and timing information and location information associated with the inserted one or more additional objects.

14. The system of claim 13, wherein the one or more objects are comprised of text, an image, an audio file, a hyperlink, and combinations thereof.

15. The system of claim 13, wherein the one or more commands are initiated by one or more of a keyboard entry, a pointing device click, a menu section, a drag-and-drop, or combinations thereof.

16. The system of claim 15, wherein the multimedia content engine is further configured to display audio content using the dynamic display.

17. (canceled)

18. The system of claim 13, wherein the non-linear video content is comprised of a collection of segments ordered according to a download priority generated in real-time.

19. The system of claim 13, wherein the one or more displayed objects are displayed at a playback time of the non-linear video content and at a coordinate location on the non-linear video content retrieved from the database and associated with the one or more displayed objects.

20. The system of claim 13, further comprising receiving a plurality of objects at the object layer and displaying one or more of the plurality of objects by the object layer according to a defined policy associated with the type of content.

21. The system of claim 13, wherein the object layer is further configured to display object information about one or more objects to be displayed with the multimedia content.
